(19) United States
(12) Patent Application Publication
(10) Pub. No.: US 2009/0311341 A1
(43) Pub. Date: Dec. 17, 2009

(54) METHOD OF APPLYING A DISPERSION

(76) Inventors: Manfred Nagel, Maintal (DE); Josef Piroth, Mespelbrunn (DE); Dirk Schäffner, Bellheim (DE); Norbert Krebs, Langenselbold (DE)

Correspondence Address: SMITH, GAMBRELL & RUSSELL, SUITE 3100, PROMENADE II, 1230 PEACHTREE STREET, N.E., ATLANTA, GA, 30309-3592, US

(21) Appl. No.: 12/375,885

(22) PCT Filed: Jul. 13, 2007
(86) PCT No.: PCT/EP07/57220

§ 371 Date: Jan. 30, 2009

(30) Foreign Application Priority Data
Aug. 12, 2006 (DE) 102006037822.9

(51) Int. Cl. A01N 59/00; A01P 7/04

(52) U.S. Cl. 424/600

(57) ABSTRACT

Aqueous dispersions of hydrophobic silicic acid are applied using a two-substance nozzle.

The aqueous dispersion is employed as insecticide.

### INTRODUCTION AND BACKGROUND

The invention relates to a method of applying a dispersion of hydrophobic silicic acid.

DE 10 2004 021 532 and WO 2005/104851 disclose an insecticidally active dispersion.

In addition to water, this dispersion contains 0.5 to 20% by weight of hydrophobic silicic acid, 0.01 to 10% by weight of a gelling, or viscosity-increasing, additive, 0.1 to 1% by weight of a preservative, 0 to 1% by weight of a surface-activating substance.

The known dispersion has an insecticidal activity and can therefore be employed for example against mites, beetles, moths, lice and the like.

To apply the dispersion as insecticidal composition, it is necessary to distribute this dispersion in a suitable form.

The problem was to find a method of applying and promoting a dispersion by means of which the insecticidally active dispersion can be applied in such a way that maximum activity results.

### SUMMARY OF INVENTION

The invention relates to a method of applying an insecticidally active aqueous dispersion which contains a hydrophobic silicic acid, characterized in that a two-substance nozzle is used.

The hydrophobic silicic acid employed may be a fumed hydrophobicized silicic acid.

Hydrophobicized, fumed silicic acids are known from Ullman's Enzyklopädie der technischen Chemie [Ullman's Encyclopaedia of Industrial Chemistry], 4^{th edition, Vol.} 21, page 464.

In a preferred embodiment of the invention, the dispersion may contain, in addition to water, 0.5 to 20% by weight of hydrophobic silicic acid, 0.01 to 10% by weight of a gelling, or viscosity-increasing, additive, 0.1 to 1% by weight of a preservative, 0 to 1% by weight of a surface-activating substance. An aqueous dispersion as described in DE 10 2004 021 532 or WO 2005/104851 may be employed, in particular.

### DETAILED DESCRIPTION OF INVENTION

In a preferred embodiment of the invention, the dispersion can be discharged by means of a two-substance nozzle, by means of which the dispersion is finely atomized by means of a gas, such as, for example, air.

The method according to the invention has the advantage that fine drops can be formed, which results in better nebulization. The fine nebule is required for obtaining a more uniform, more complete coating of the surfaces. This ensures a high activity. Moreover, the insecticidal dispersion retains the insecticidal activity.

The use of the two-substance nozzle is advantageous because the discharge of a fine nebule by means of a one-substance nozzle entails an unduly high pressure, which destroys the insecticidal dispersion, which thus looses its activity. In particular, the hydrophobicity of the silicic acid is destroyed, making the silicic acid hydrophilic. As a result, the insecticidal activity is lost.

In one embodiment of the invention, the aqueous dispersion of the hydrophobic silicic acid can be conveyed to the discharge nozzle by conveying the dispersion in a pipeline and moving the dispersion on within the pipeline by means of a rolling motion.

The rolling motion can be carried out by means of a hose pump, hose-type screw pump, peristaltic pump or rotary positive-displacement pump.

A peristaltic pump or rotary positive-displacement pump is known from DE 197 13 689 or DE 197 17 452.

### EXAMPLES

Parameters for the two-substance version:
atomization pressure liquid 1-3 bar atomization pressure gas 1-5 bar

Comparison one-substance/two-substance atomization of the insecticidal dispersion with regard to droplet size and mortality (activity)

| Type of | Atomization | | Mortality |
|---|---|---|---|
| atomization | pressure | Droplet size | (activity) |
| One-substance | 10 bar | >>200 | 100% |
| (low pressure) | | micrometers | |
| | | (coarse spray) | |
| One-substance | 100 bar | <200 | 0% |
| (high pressure) | | micrometers | |
| | | (fine spray) | |
| Two-substance | 3 bar | <200 | 100% |
| | | micrometers | |
| | | (fine spray) | |

### DETAILED DESCRIPTION OF DRAWINGS

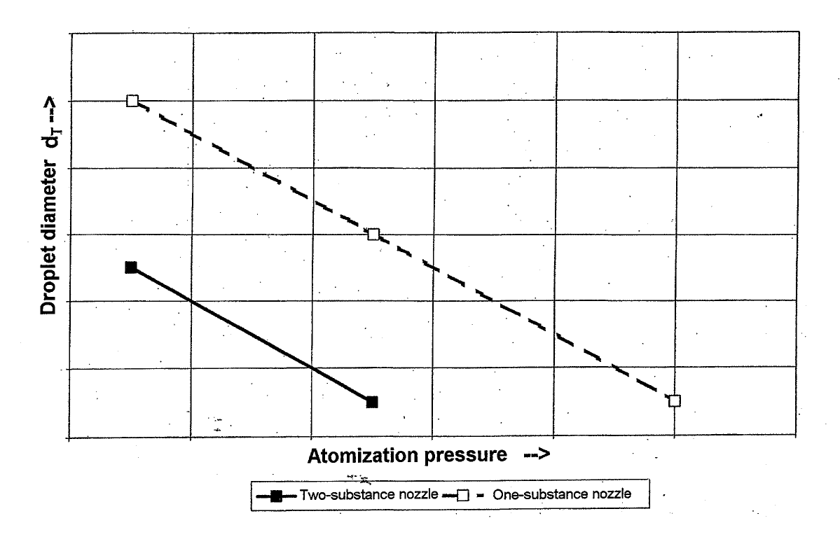

A graphic comparison of the droplet size is shown in FIG. 1.

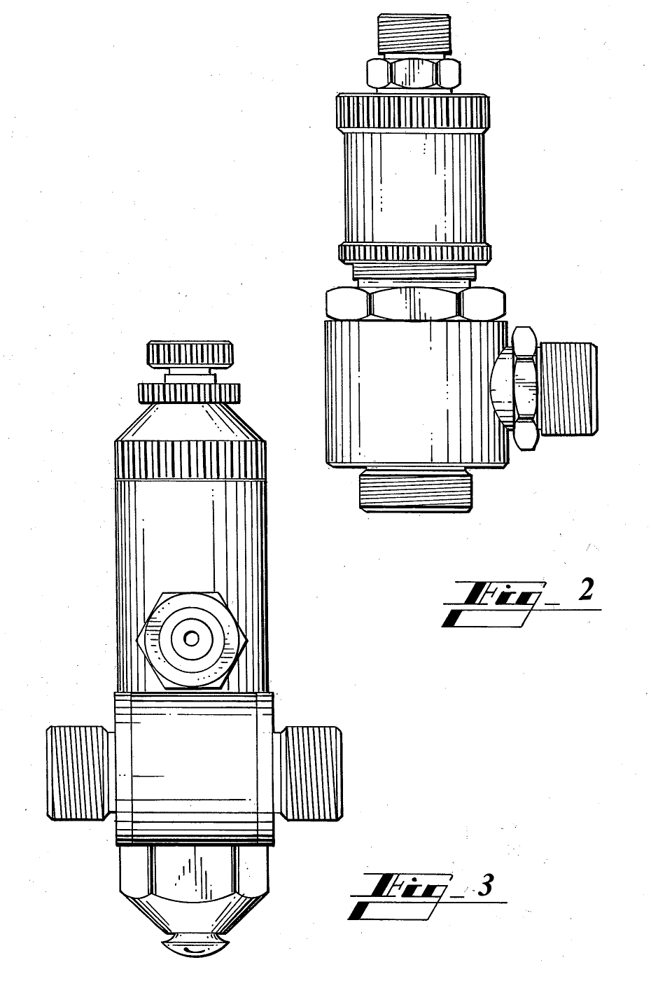

FIG. 2 shows a two-substance nozzle

FIG. 3 shows another type of two-substance nozzle

1. Method of applying an insecticidally active aqueous dispersion which contains a hydrophobic silicic acid, wherein a two-substance nozzle is used.
